(19) United States
(12) Patent Application Publication
(10) Pub. No.: US 2025/0363495 A1
(43) Pub. Date: Nov. 27, 2025

(54) BIOMETRIC AUTHENTICATED FINANCIAL TRANSFERS

(71) Applicant: Mastercard International Incorporated, Purchase, NY (US)

(72) Inventors: Michael Jason Friedman, Stamford, CT (US); Janine Lafond, Katonah, NY (US)

(21) Appl. No.: 19/212,309

(22) Filed: May 19, 2025

Related U.S. Application Data
(60) Provisional application No. 63/650,981, filed on May 23, 2024.

(51) Int. Cl. G06Q 20/40; G06Q 20/02; G06Q 20/10; G06Q 20/32

(52) U.S. Cl. CPC G06Q 20/40145; G06Q 20/02; G06Q 20/108; G06Q 20/3223; G06Q 20/4016

(57) ABSTRACT

A payment system is provided for transferring a financial amount between two parties. The first party captures a biometric characteristic like a facial image of the second party. The first party then sends the captured biometric characteristic to a transaction processor. The transaction processor then compares the biometric characteristic with a stored copy of the biometric characteristic which is also associated with the second party. The first party then receives an authentication message indicating that the biometric characteristic matches the stored copy of the biometric characteristic. In response to the authentication message, the first party then authorizes a transfer of a financial amount from the first party to the second party.

### CROSS REFERENCE TO RELATED APPLICATIONS

This application claims the benefit of U.S. provisional application No. 63/650,981 filed on May 23, 2024, which is incorporated by reference herein.

### BACKGROUND

The present inventions relate generally to financial transaction processing, and more particularly, to the use of biometric authentication in authorizing the transfer of a financial amount from a first party to a second party.

A variety of payment systems are available for individuals to make payments to other individuals in exchange for services, goods or as gifts. However, fraudulent activity continues to be a concern for such systems. For example, one type of fraudulent activity involves imposter fraud. In this situation, one individual desires to pay another individual a certain amount of money, but the individual receiving the money is actually an imposter pretending to be the one who the payor wishes to pay. Imposter fraud is one of the most common types of fraud affecting conventional payment systems.

In some payment systems, such as credit card systems, a third-party transaction processor (e.g., Mastercard, Visa, Discover) employs sophisticated processes to identify imposter fraud. Since such payment systems involve a rather lengthy authorization and clearing process for completing financial transfers, the transaction processor has multiple opportunities to identify and halt any imposter fraud. However, in view of the many different types of payment systems that now exist, not all payment systems are equipped to adequately deal with imposter fraud.

Thus, individuals wishing to make payments to other individuals may still be at risk of imposter fraud. For example, imposter fraud can be more difficult to deal with in cash-based payment systems where a financial amount is transferred directly from the payor's bank account to the payee's bank account without an extensive clearing process therebetween. These types of transactions can be referred to as account-to-account transfers. The problem with these types of transfers is that it can be difficult for the payor to recover a financial amount that has already been transferred to another account if the imposter fraud is only discovered after the transfer has been completed.

Therefore, it would be desirable for individuals to be able to identify and prevent imposter fraud as early as possible before financial transactions are complete.

### SUMMARY

A payment system is described for transferring a financial amount from a payor to a payee. In the system, the payor captures a biometric characteristic of the payee and sends the biometric characteristic to a transaction processor. The transaction processor may search a biometric database to find a match between the received biometric characteristic and stored copies of biometric characteristics of potential payees. When the transaction processor finds a match, the transaction processor may send a notification message to the payee, and the payee may send an authentication message to the payor in response to the notification message. The payor then sends an authorization message to the transaction processor in response to the authentication message in which the payor authorizes the transaction processor to initiate a transfer of a financial amount from the payor's financial account to the payee's financial account. Preferably, the transfer is done without the payor and the payee exchanging any account information between them. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawing, in which:

FIG. 1 illustrates an exemplary method of transferring a financial amount from a payor to a payee;

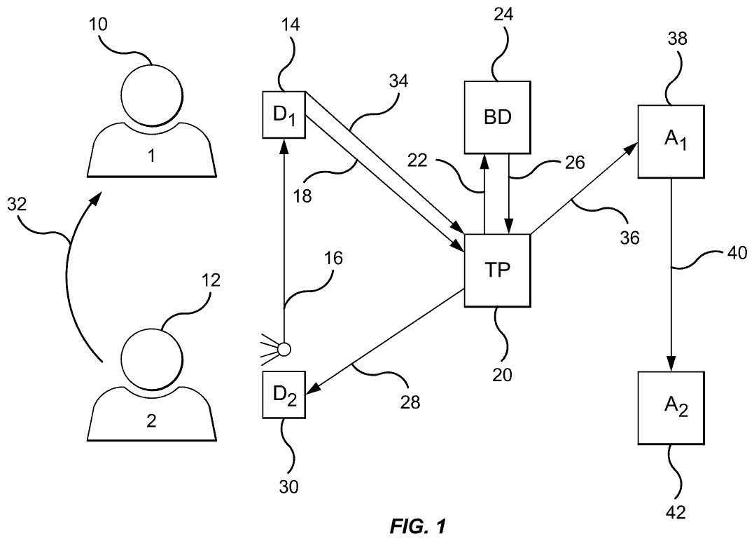

FIG. 2 is a flowchart illustrating an exemplary method of transferring a financial amount from a payor to a payee; and

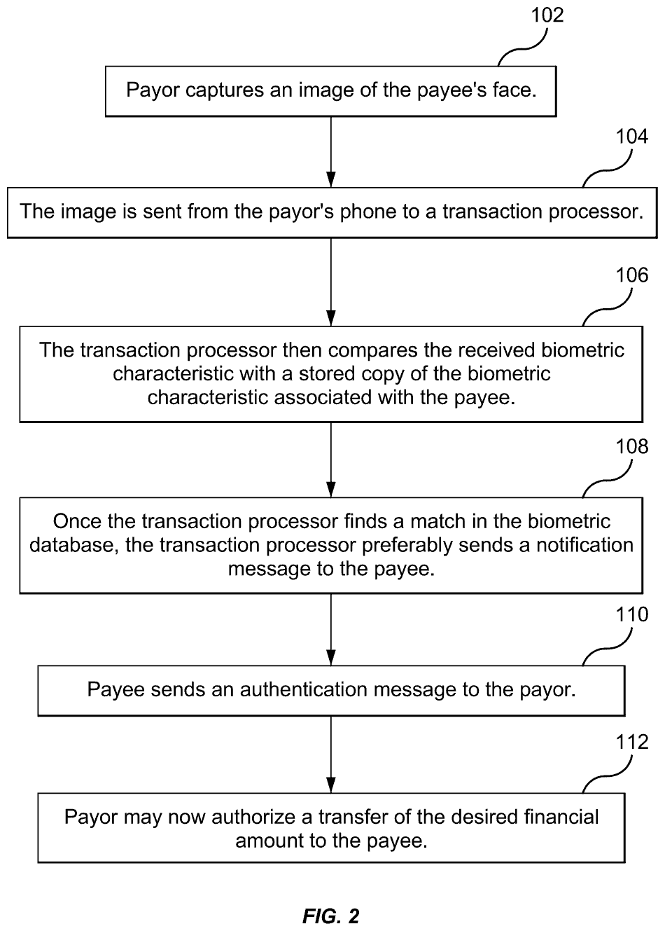

FIG. 3 illustrates an exemplary method of transferring a financial amount from a payor to a payee.

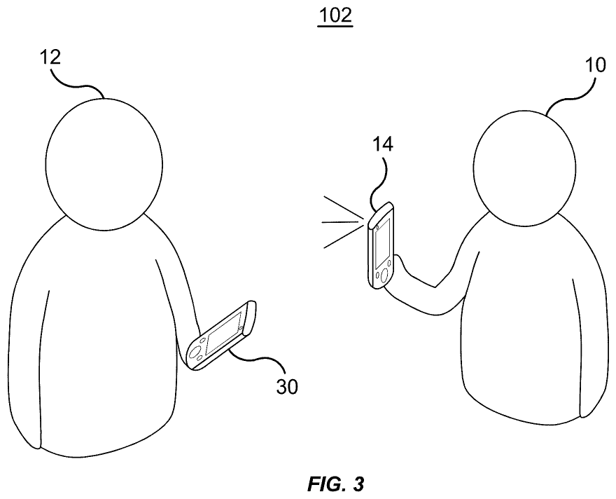

### DETAILED DESCRIPTION

Referring now to the figures, a payment system is shown for transferring a financial amount from a payor 10 (the first party 10) to a payee 12 (the second party 12). The described system is particularly useful where the payor 10 and the payee 12 are individuals who do not know each other personally. One such example is a restaurant customer 10 who wishes to tip a valet 12 as the customer 10 leaves the restaurant. Although historically such payments were often done with actual cash, most individuals nowadays prefer not to handle actual cash, and instead, prefer to make such payments digitally with a device 14, such as a personal mobile phone 14. However, the described payment system may be useful in numerous other scenarios.

The payor 10 begins the payment process by capturing 16, 102 a biometric characteristic of the payee 12 using the payor's own mobile phone 14 (first device 14). For example, this may be done by the payor 10 holding up their phone 14 and taking a picture of the payee's face 12. However, other biometric characteristics like fingerprints may also be used. Preferably, the payor 10 has a special software payment application loaded on their phone 14 to handle all of the described steps herein involving the payor's phone 14. In other words, while it is possible for the payor 10 to use a standalone camera app on their phone 14 and may send the photo using a separate standalone communications app, it is preferable for the payor 10 to use a special payment app which has camera, communications and reporting functionality built into the payment app.

After the payor 10 captures 16 an image of the payee's face 12, the image is sent 18, 104 from the payor's phone 14 to a transaction processor 20 (third party 20). Although the image may be sent 18 as the original, full facial image of the payee 12, it may be preferred for a representation of the facial image to be sent 18 to the transaction processor 20. For example, it is known that facial images (as well as other biometric characteristics) can be converted into a biometric template that retains key biometric features and discards less useful data. Such biometric templates may also utilize encryption to protect the biometric data during data transmissions. Thus, where a biometric template is used, it is preferable for the biometric characteristic to be converted into the template before sending 18 the biometric data to the transaction processor 20, with the template taking the place of the captured biometric characteristic. The template conversion may be done by the special payment app loaded on the payor's phone 14 which is also used for capturing 16 the payee's facial image 12 and sending 18 the biometric data to the transaction processor 20. The transaction processor 20 then compares 22, 106 the received biometric characteristic with a stored copy 24 of the biometric characteristic associated with the payee 12. This will typically require the payee 12 to be registered with the transaction processor 20 by providing the transaction processor 20 with a copy 24 of their biometric characteristic (e.g., a prior picture 24 of their face). Registration of the payee 12 preferably also involves the payee 12 providing the transaction processor 20 with account information for a financial account 42 to which financial amounts are to be transferred as well as other personal information about the payee 12. In one embodiment, the transaction processor 20 compares 22 the biometric characteristic of the payee 12 with a biometric database 24 that contains biometric characteristics of many different parties. For example, the transaction processor 20 may receive registrations from many payees 12 who wish to be included in the system. The transaction processor 20 may then search the database 24 using a one-to-many search (1:N) 22 to match 26 the biometric characteristic received from the payor 10 to the closest biometric characteristic stored in the biometric database 24 for registered payees 12. Thus, for example, where the biometric data received from the payor 10 is a biometric template of the payee's face 12, the transaction processor 20 may search 22 the biometric database to match 26 the received template with a stored template 24 of possible payees 12 that most closely matches the payee's face 12. However, it is desirable for the matching algorithm 22 to employ tolerance limits so that, if no stored biometric characteristic matches the biometric characteristic received from the payor 10 within the tolerance limits, the matching algorithm 22 will indicate 26 that no match has been found.

Once the transaction processor 20 finds a match 26 in the biometric database 24, the transaction processor 20 preferably sends a notification message 28, 108 to the payee 12. Preferably, the notification message 28 is sent to the payee's personal mobile phone 30 (second device 30), which may have the same special payment app loaded thereon as on the payor's mobile phone 14 in order to receive and report the notification 28 to the payee 12. Preferably, the transaction processor 20 sends the notice 28 to a phone number or other contact information that was provided by the payee 12 to the transaction processor 20 during registration which is then stored with the registered biometric characteristic 24 and is thus associated with the matched biometric characteristic 26. The payee 12 may then send an authentication message 32, 110 to the payor 10. For example, where the payor 10 and the payee 12 are located together in person, the payee 12 may hold up their phone 30 and show 32 the payor 10 the notification message 28 that has been received from the transaction processor 20. The payee 12 may also verbally inform 32 the payor 10 that they have received the notification message 28 from the transaction processor 20. Thus, in the preferred embodiment, the authentication message 32 is sent by the payee 12 to the payor 10 in response to the payee 12 receiving a notification message 28 from the transaction processor 20. However, it is possible for the payor 10 to receive the authentication message 32 in other ways, for example, directly from the transaction processor 20. It is also possible for the transaction processor 20 to send notification messages to both the payee 12 and the payor 10 with the same code in both messages. The payee 12 may then inform the payor 10 of the code received in the payee's notification which allows the payor 10 to compare the code from the payee 12 to verify if it matches the code received by the payor 10 from the transaction processor 20.

Once the payor 10 receives the authentication message 32 indicating that the captured biometric characteristic 16 matches the stored copy of the biometric characteristic 24 associated with the payee 12, the payor 10 now has a higher assurance that the correct payee 12 has been identified. Thus, the payor 10 may now authorize 34, 112 a transfer 40 of the desired financial amount from the payor 10 to the payee 12. Preferably, the authorization 34 is performed by the payor 10 through the special payment app on the payor's phone 14 which is also used for capturing the payee's biometric characteristic 16, etc. This may be done by the payor 10 pressing a pay button in the app which then causes an authorization message 34 to be sent to the transaction processor 20. In response, the transaction processor 20 may initiate 36 the transfer 40 from a financial account 38 owned by the payor 10 to a financial account 42 owned by the payee 12. Preferably, the transfer 40 is an account-to-account transfer 40 using the ACH network or similar cash-based transfer 40. Most preferably, the transfer 40 is done without the payor 10 providing their account information to the payee 12 or the payee 12 providing their account information to the payor 10. Thus, the financial accounts 38, 42 of both the payor 10 and the payee 12 may be protected since the transfer 40 of the financial amount may be done without sharing the associated account information with either the payor 10 or the payee 12. This may be accomplished by the payor 10 by sending their financial account information to the transaction processor 20 so that the transaction processor 20 knows what financial account 38 to transfer 40 the financial amount from. Separately, the payee 12 may also provide the transaction processor 20 with their financial account information so that the transaction processor 20 knows what financial account 42 to transfer 40 the financial amount to. Again, this is preferably done using the special payment app loaded on the payor's and payee's phones 14, 30. It is also possible for the transaction processor 20 to obtain the payee's account information during the registration process and for the account information to be stored with the stored biometric characteristic 24 so that the transaction processor 20 is able to initiate 36 the transfer 40 without separately obtaining the payee's account information at the time of the transfer 40. Additionally, the payor's and payee's financial account information may be stored as default settings in the special payment app on their phones 14, 30 so that the payor's and payee's financial account information is sent automatically to the transaction processor 20 at the time of the transfer 40 without the payor 10 or the payee 12 needing to manually enter the information at the time of the transfer 40.

The described payment system may also include other safety mechanisms as well. For example, because many transfers 40 using this system will be between individuals who do not personally know each other, it may be preferable for the transaction processor 20 to limit such transfers 40 to a specific monetary value. For example, it may be desirable to limit use of the payment system to transfers 40 of $50 or less. It may also be desirable to incorporate geographical information into the authorization process. For example, it may be desirable for one or both of the payor's and the payee's phones 14, 30 to send geographical information to the transaction processor 20 indicating where the respective phones 14, 30 are currently located so that the transaction processor 20 can confirm that both phones 14, 30 are located near each other. The geographical information may then be used to prevent a transfer 40 if the phones 14, 30 are not located near each other; the geographical information of the payee's phone 30 may be shared with the payor 10 by the transaction processor 20 so that the payor 10 can decide if the transfer 40 should be authorized 34; or the transaction processor 20 can compare the payee's phone 30 location with an expected phone location to determine whether fraud may be involved. The transaction processor 20 may also manage the biometric database 24 in a way that minimizes fraud. For example, if an individual has been determined to have engaged in fraudulent activities, those individuals may be excluded from the payment system. In this scenario, when the transaction processor 20 searches the biometric database 24, no match would be found and the payor 10 can be alerted that there is no match. Alternatively, the biometric database 24 may include flags associated with questionable payees. Thus, the transaction processor 20 may send this flagged information to the payor 10 when a match 26 is found but before the payor 10 has authorized 34 the transfer 40 so that the payor 10 may reconsider whether they want to authorize 34 the transfer 40. For example, the transaction processor 20 could send a notification to the payor 10 that the payee 12 is a high risk individual (e.g., has previously engaged in fraudulent activity). It is also possible for the transaction processor 20 to retain employment information for individuals in the biometric database 24. Such employment information may be shared with the payor 10 to verify that the potential payee 12 is someone who the payor 10 actually intends to pay. Alternatively, where the payor 10 is intending to pay a merchant 12 (as opposed to an individual person), the employment information may be used to verify that the individual 12 with whom the payor 10 is interacting is actually an employee of the merchant 12.

It is understood that the described payment system is intended to operate autonomously on programmed computer systems utilizing computer algorithms such that the system may be implemented by one or more computer processors (e.g., in a server system) executing computer-executable instructions stored on a non-transitory computer-readable storage medium. Thus, for example, in the case of the transaction processor 20 and other steps described herein, it is unnecessary for human beings to make the required data transmissions, determinations, etc., except where it is specifically described that individuals provide particular inputs. This autonomous design makes the payment system scalable to a level that would be impractical if human beings were to attempt to perform the steps required by the system. While it is understood that various human beings may provide inputs to the system and may adjust parameters that control how the system operates, the payment system is intended to have the capability of processing many thousands of transfers in short periods of time (e.g., seconds or less) that would be impossible to accomplish with human intervention in each transaction.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A method of transferring a financial amount between a first party and a second party, comprising:
the first party capturing a biometric characteristic of the second party with a first device;
the first device sending the biometric characteristic or a representation thereof to a third party;
the third party comparing the biometric characteristic with a stored copy of the biometric characteristic associated with the second party;
the first party receiving an authentication message indicating that the biometric characteristic matches the stored copy of the biometric characteristic; and
the first party authorizing a transfer of the financial amount from the first party to the second party in response to receiving the authentication message.

2. The method of transferring a financial amount between a first party and a second party according to claim 1, wherein the first device comprises a mobile phone associated with the first party.

3. The method of transferring a financial amount between a first party and a second party according to claim 1, wherein the first device comprises a payment application configured to capture the biometric characteristic.

4. The method of transferring a financial amount between a first party and a second party according to claim 1, wherein capturing the biometric characteristic comprises taking a picture of a face of the second party.

5. The method of transferring a financial amount between a first party and a second party according to claim 1, wherein sending the biometric characteristic or the representation thereof to the third party comprises converting the captured biometric characteristic into a biometric template prior to sending, and sending the biometric template in place of the captured biometric characteristic.

6. The method of transferring a financial amount between a first party and a second party according to claim 5, wherein the captured biometric characteristic is converted into the biometric template by the first device.

7. The method of transferring a financial amount between a first party and a second party according to claim 1, wherein the third party comparing the biometric characteristic with the stored copy of the biometric characteristic associated with the second party comprises searching a biometric database comprising biometric characteristics of many different parties, and matching the biometric characteristic received from the first party with a closest one of the biometric characteristics in the biometric database.

8. The method of transferring a financial amount between a first party and a second party according to claim 7, wherein the biometric characteristics of the many different parties are biometric templates of each of the many different parties' faces.

9. The method of transferring a financial amount between a first party and a second party according to claim 1, wherein the transfer of the financial amount from the first party to the second party comprises an account-to-account transfer.

10. The method of transferring a financial amount between a first party and a second party according to claim 1, wherein the first party does not provide account information to the second party associated with a financial account from which the financial amount is to be transferred from.

11. The method of transferring a financial amount between a first party and a second party according to claim 1, wherein the second party does not provide account information to the first party associated with a financial account to which the financial amount is to be transferred to.

12. The method of transferring a financial amount between a first party and a second party according to claim 1, wherein the first party authorizing the transfer of the financial amount from the first party to the second party comprises the first party sending an authorization message to the third party, the third party initiating the transfer from a financial account of the first party to a financial account of the second party.

13. The method of transferring a financial amount between a first party and a second party according to claim 12, wherein the financial account of the first party is sent by the first party to the third party, and the financial account of the second party is sent by the second party to the third party.

14. The method of transferring a financial amount between a first party and a second party according to claim 1, wherein the financial amount is limited by the third party to $50 or less.

15. The method of transferring a financial amount between a first party and a second party according to claim 1, wherein the first party receiving the authentication message comprises the second party receiving a notification message from the third party with a second device associated with the stored copy of the biometric characteristic, the second party sending the authentication message to the first party in response to the notification message.

16. The method of transferring a financial amount between a first party and a second party according to claim 15, wherein the second device comprises a mobile phone associated with the second party, contact information for the mobile phone of the second party being stored with the stored copy of the biometric characteristic.

17. The method of transferring a financial amount between a first party and a second party according to claim 15, wherein the second party sends the authentication message to the first party in person.

18. The method of transferring a financial amount between a first party and a second party according to claim 15, wherein the authentication message sent by the second party to the first party contains a code included in the notification message sent from the third party to the second party, the third party also sending another notification message to the first party with a matching code, and the first party comparing the code received from the second party with the matching code received from the third party to verify a match.

19. The method of transferring a financial amount between a first party and a second party according to claim 1, wherein the third party maintains a biometric database comprising biometric characteristics of many different parties, the stored copy of the biometric characteristic being stored in the biometric database, and the third party sends a notification to the first party if the second party has been previously identified as engaging in fraudulent activity.

20. The method of transferring a financial amount between a first party and a second party according to claim 1, wherein the first device comprises a software payment app configured to capture the biometric characteristic, send the biometric characteristic or the representation thereof to the third party and send an authorization message to the third party to authorize the transfer of the financial amount from the first party to the second party.
